(19) United States
(12) Patent Application Publication
(10) Pub. No.: US 2026/0319759 A1
(43) Pub. Date: Oct. 15, 2026

(54) Compact Enum References

(71) Applicant: Oracle International Corporation, Redwood Shores, CA (US)

(72) Inventor: John Robert Rose, San Jose, CA (US)

(73) Assignee: Oracle International Corporation, Redwood Shores, CA (US)

(21) Appl. No.: 19/178,201

(22) Filed: Apr. 14, 2025

(51) Int. Cl. G06F 8/30

(52) U.S. Cl. CPC G06F 8/315

(57) ABSTRACT

Techniques for generating and resolving compact enum references are disclosed. A virtual machine (VM) detects an instruction to store a reference to an enum value of an enum type. Responsive to encountering the instruction to store the reference to the enum value, the VM determines an ordinal position of the enum value in an enum lookup array that includes a set of possible values of the enum type. The VM stores the ordinal position of the enum value as the reference to the enum value of the enum type.

### TECHNICAL FIELD

The present disclosure relates to computer programming. In particular, the present disclosure relates to enumerations in computer programming.

### BACKGROUND

In computer programming, an enum (short for “enumeration”) is a data structure that represents a finite set of constants. An enum instance is an instance of an enum type and stores a specific value. For example, an enum with four possible non-null values includes four enum instances that store the corresponding non-null values of the enum. An enum field is a field (e.g., a local variable or constant) declared as an enum type. Because enum values are constants, enum fields that are assigned the same enum value will reference the same enum instance.

In the Java programming language, the form of an enum declaration is the keyword “enum” followed by the enum name and a comma-separated list of constants between braces. For example:
enum Suit {HEART, SPADE, DIAMOND, CLUB}
   A Java enum with N user-defined values has N+1 possible values: the N user-defined values and null. In the example above, the Suit enum has five possible values: HEART, SPADE, DIAMOND, CLUB, and null.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 shows a block diagram that illustrates a JVM in accordance with one or more embodiments;

FIG. 6 shows a flowchart of operations for generating an enum lookup array in accordance with one or more embodiments;

FIG. 7 shows a flowchart of operations for generating a compact enum reference in accordance with one or more embodiments;

FIG. 8 shows a flowchart of operations for resolving an enum field using a compact enum reference in accordance with one or more embodiments;

FIG. 9 shows a flowchart of operations for handling an attempt to add an enum value to an enum type after class initialization, in accordance with one or more embodiments;

FIG. 10 shows a flowchart of operations for enforcing a load order that supports compact enum types in accordance with one or more embodiments;

FIG. 11 shows another flowchart of operations for enforcing a load order that supports compact enum types in accordance with one or more embodiments;

FIG. 12 shows a block diagram that illustrates an example of compact enum references in accordance with one or more embodiments; and

FIG. 13 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. SYSTEM USING COMPACT ENUM REFERENCES
4. OPERATIONS FOR USING COMPACT ENUM REFERENCES
   4.1. GENERATING AN ENUM LOOKUP ARRAY
   4.2. GENERATING A COMPACT ENUM REFERENCE
   4.3. RESOLVING AN ENUM FIELD USING A COMPACT ENUM REFERENCE
   4.4. ADDITIONAL SUPPORTS FOR COMPACT ENUM REFERENCES
5. EXAMPLE OF COMPACT ENUM REFERENCES
6. USING COMPACT ENUM REFERENCES WITH NON-NULLABLE FIELDS
7. USING COMPACT ENUM REFERENCES WITH VALUE TYPES
8. HARDWARE OVERVIEW
9. MISCELLANEOUS; EXTENSIONS

### 1. General Overview

One or more embodiments generate compact enum references that occupy less memory than standard enum references (e.g., only one or two bytes, instead of four or eight bytes). Specifically, one or more embodiments generate an enum lookup array in which enum instances can be accessed by their ordinal positions in the array. As used herein, an ordinal position is a numerical index into the array. For example, if counting begins at 0, the first element in the array is at ordinal position 0, the second element in the array is at ordinal position 1, etc. Instead of using a standard object reference for an enum value, one or more embodiments use the ordinal position of the corresponding enum instance as the enum reference. To resolve an enum field using a compact enum reference, one or more embodiments use the ordinal position from the compact enum reference to access the enum instance at that position in the enum lookup array. The enum field resolves as the value of that enum instance.

In general, using less memory for enum references frees up memory for other uses, improving the overall performance of the computer system without needing to install or provision more memory. Compact enum references may be particularly helpful in applications that use large numbers of enums, because the amount of memory saved expands linearly with the number of enum references. In addition, one or more embodiments may be used with enums as value types, adding to the memory-sparing benefits of value types.

One or more embodiments generate compact enum references transparently, without requiring a programmer to modify code or instruct a virtual machine or compiler to use compact enum references. Transparent optimization of enum references improves system performance even if the programmer is not aware of the optimization or forgets to apply the optimization.

Examples are discussed herein with respect to the Java programming language. However, embodiments may be used with other programming languages that support the techniques described herein. Accordingly, discussions herein relating to Java should be construed as applying, mutatis mutandis, to other compatible languages.

One or more embodiments described in this Specification and/or recited in the claims may not be included in this General Overview section.

### 2. Architectural Overview

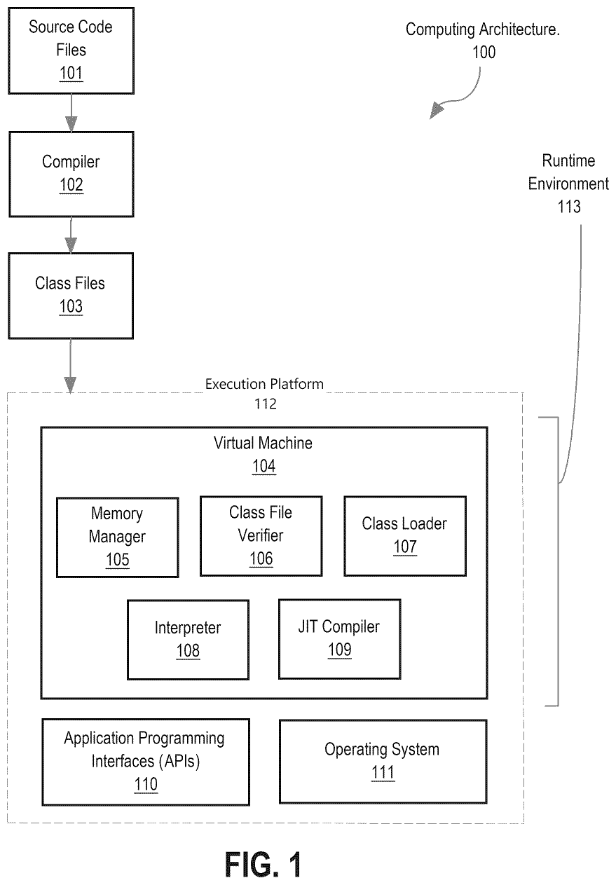

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

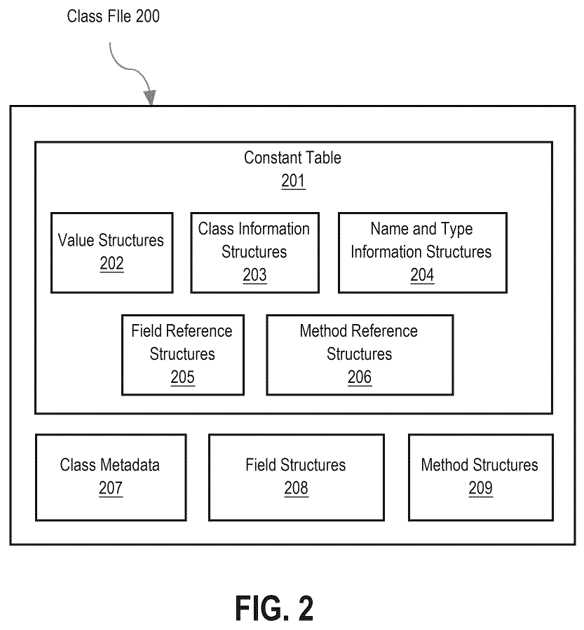

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g. “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:

```
class A
{
  int add12and13( ) {
    return B.addTwo(12, 13);
  }
}
```

In the above example, the Java method add12andl3 is defined in class A, takes no parameters, and returns an integer. The body of method add12and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

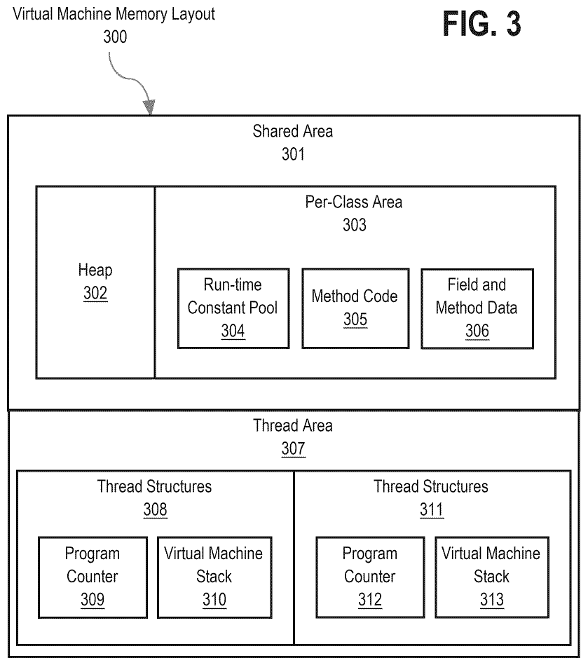

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

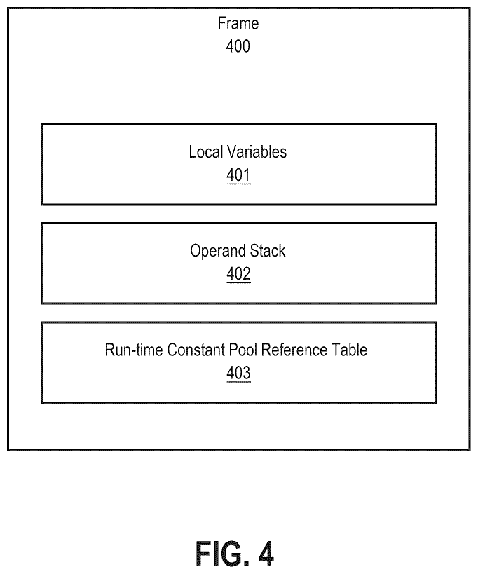

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the runtime state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. System Using Compact Enum References

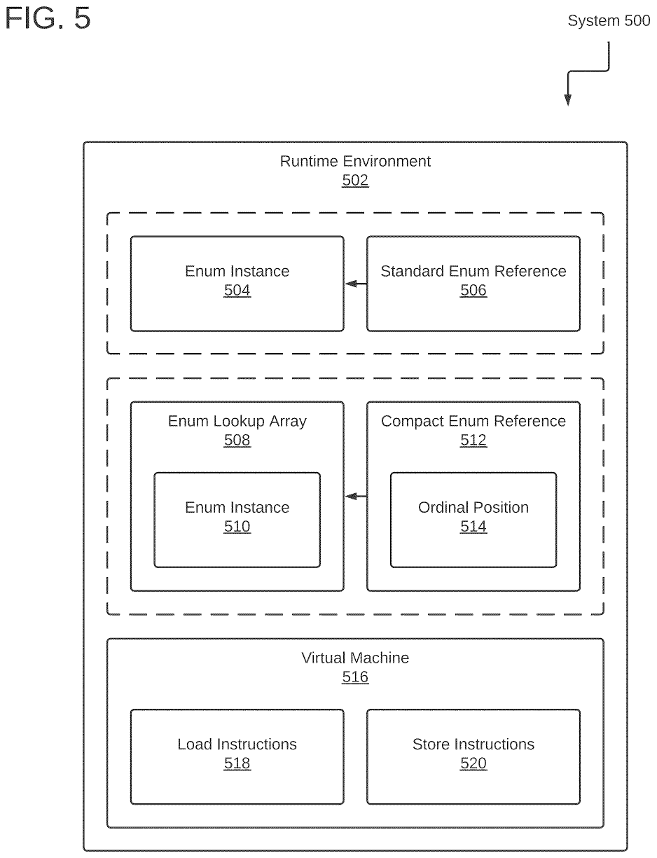

FIG. 5 shows a block diagram that illustrates a system 500 in accordance with one or more embodiments. System 500 includes an enum instance 504 referenced by one or more standard enum references 506, one or more enum lookup arrays 508 storing one or more enum instances 510 at respective ordinal positions, a compact enum reference 512 that references an ordinal position 514 in the enum lookup array 508, and a virtual machine (VM) 516 that includes load instructions 518 and store instructions 520.

In one or more embodiments, system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

In an embodiment, an enum instance 504 is an instance of an enum type and stores a specific value. A standard enum reference 506 is a standard object reference that indicates the memory location of an enum instance 504. In Java, a standard enum reference 506 can consume as much as 8 bytes of memory. Thus, an application with N enum fields can consume up to 8×N bytes of memory for those references.

In an embodiment, an enum lookup array 508 is a data structure configured to store one or more enum instances 510 at respective ordinal positions. For example, the first enum instance 510 in the enum lookup array 508 may be stored at ordinal position 0, the second enum instance 510 in the enum lookup array 508 may be stored at ordinal position 1, etc. In some embodiments described herein, the first enum instance 510 in the enum lookup array 508 is the null value. An enum lookup array 508 is not necessarily implemented as an array data structure; it may instead be implemented as a table, dictionary, map, or other data structure capable of associating enum instances 510 with respective ordinal positions. One or more embodiments store multiple enum lookup arrays 508 corresponding respectively to multiple enums. In the playing card example, system 500 may store one enum lookup array 508 for values of a Suit enum and another enum lookup array 508 for values of a Rank enum.

In an embodiment, a compact enum reference 512 includes an ordinal position 514 that serves as an index into an enum lookup array 508. Specifically, a compact enum reference 512 references an enum instance 510 stored at the designated ordinal position 514 in the enum lookup array 508. In general, an ordinal position 514 requires less memory than a memory address. For example, because a byte is 8 bits and 2⁸=256, representing all the possible ordinal positions in an enum lookup array with many (up to 256) possible values requires only a single byte. If the enum lookup array has fewer than 256 values, some byte values are available for other control purposes, such as representing a distinct null value as discussed herein. Even if the number of enum instances 510 in enum lookup array 508 could be represented in fewer bits, one or more embodiments use a standard memory increment of one byte to store ordinal position 514. If an enum has more than 256 possible values, one or more embodiments may store ordinal positions in more than one byte.

One or more embodiments may store compact enum references in a bitmap (not shown in FIG. 1). Using a bitmap allows for multiple compact enum references to be stored in a single byte and/or to span byte boundaries. For example, an ordinary deck of cards includes 4 suits and 13 ranks (excluding jokers). Including the null value, an enum for suits would have 5 possible values and an enum for ranks would have 14 possible values. Using a bitmap, a single card could be represented by two compact enum references occupying a total of 7 bits:3 bits (up to 8 possible values) for an ordinal position that maps to the suit value in an enum lookup array and 4 bits (up to 16 possible values) for an ordinal position that maps to the rank value in another enum lookup array. If the null value is excluded from the enum lookup array using techniques described herein, the enum for suits would have only 4 possible values and the corresponding ordinal position could be reduced to only 2 bits. Using a bitmap to store compact enum references further reduces the memory footprint of enum fields.

In an embodiment, runtime environment 502 is a Java runtime environment (JRE) and VM 516 is a Java virtual machine (JVM). VM 516 may be configured to execute Java bytecode that is compiled from Java source code. Examples of a runtime environment and VM in accordance with one or more embodiments are discussed in further detail above.

In an embodiment, load instructions 518 are instructions that load field values from memory. For example, when reading the value of a local variable or constant, load instructions 518 retrieve the value from its location in memory. Load instructions 518 are transparent to computer programmers, meaning that computer programmers do not need to know the details of how load instructions 518 work or interact with load instructions 518 directly.

In an embodiment, load instructions 518 include instructions for loading an enum value from memory. Specifically, load instructions 518 include instructions that accept an enum reference and return the corresponding enum value. Load instructions 518 may support both standard enum references 506 and compact enum references 512. As noted above, a standard enum reference 506 indicates the memory location of an enum instance 504. Load instructions 518 retrieve the value of the enum instance 504 stored at the designated memory location. For a compact enum reference 512, load instructions 518 use the ordinal position 514 as an index into the enum lookup array 508 and retrieve the value of the enum instance 510 stored at that ordinal position 514.

In an embodiment, store instructions 520 are instructions that store field values into memory. For example, when assigning a value to a local variable or constant, store instructions 520 write the value into memory; load instructions 518 can then retrieve the value from that location. If the field value is an object, store instructions 520 write a reference to the object's memory location. Store instructions 520 are transparent to computer programmers, meaning that most computer programmers do not need to know the details of how store instructions 520 work or interact with store instructions 520 directly.

In an embodiment, store instructions 520 include instructions for storing the value of an enum field into memory. Store instructions 520 may support both standard enum references 506 and compact enum references 512. To store a standard enum reference 504, store instructions 520 write the memory location of the enum instance 504 itself. To store a compact enum reference 512, store instructions 520 write the ordinal position 514 of the enum instance 510 in the enum lookup array 508.

Operations for generating an enum lookup array 508, generating a compact enum reference 512, and resolving a compact enum reference 512 are described in further detail below.

### 4. Operations for Using Compact Enum References

### 4.1. Generating an Enum Lookup Array

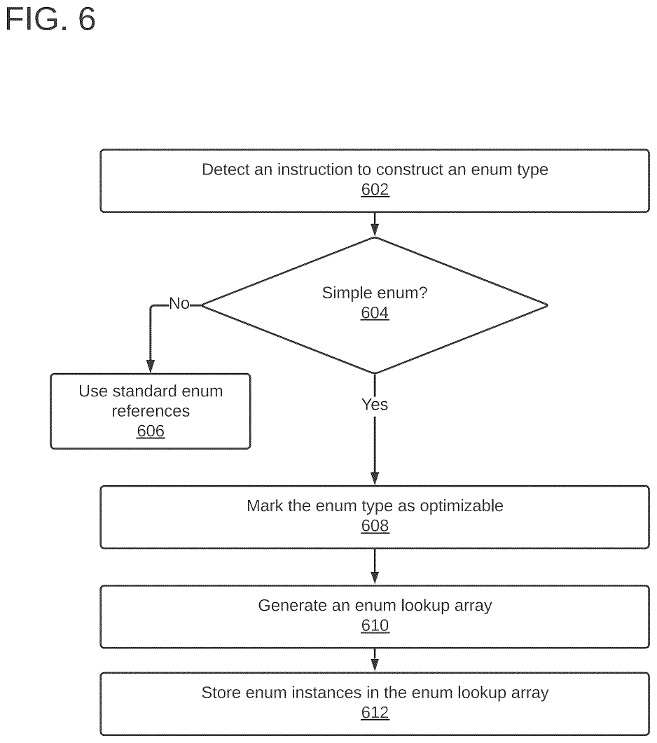

FIG. 6 shows a flowchart of operations for generating an enum lookup array in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, a system (e.g., system 500 of FIG. 5) detects an instruction to construct an enum type (Operation 602). For example, a VM may detect an instruction to construct an enum type during a class initialization phase. The system may encounter the instruction while interpreting bytecode. In an embodiment, the instruction to construct the enum type is an instruction that declares the enum type and its possible values. The declaration is a signal to the system that the enum type needs to be constructed.

In an embodiment, compact enum references are available only for simple enums, i.e., enums that are defined in a way that does not allow for dynamic creation of additional members outside of what is defined in the enum type's class file. The system determines if the enum type corresponds to a simple enum (Operation 604). If the enum type does not correspond to a simple enum, then the enum type does not support compact enum references. In this case, the system uses standard enum references for enum fields (Operation 606). Additionally or alternatively, one or more embodiments may support compact enum references for enums that support dynamic creation of additional members. In such cases, the ability to dynamically create additional members may be limited to a number of members supported by the memory size of a compact enum.

If the enum type corresponds to a simple enum, then the enum type supports compact enum references. The system may mark the enum type as optimizable (Operation 608), i.e., as supporting compact enum references. To mark the enum type as optimizable, the system may store a flag and/or annotation in association with the enum type. As discussed in further detail below, the system may subsequently use the marking to determine if an enum reference is a standard enum reference or a compact enum reference.

Responsive to determining that the enum type supports compact enum types, the system generates an enum lookup array (Operation 610). The enum lookup array may have a dimension of N, where N is the number of user-specific values of the enum. Alternatively, if the enum lookup array includes the null value, it may have a dimension of N+1. In general, generating an enum lookup array instantiates a data structure used to store enum instances associated with corresponding ordinal positions.

In an embodiment, the system stores enum instances in the enum lookup array (Operation 612). Specifically, the system stores enum instances corresponding to the possible values of the enum. In embodiments that store the null value in the enum lookup array, the system may store the null value at ordinal position 0 and user-defined enum instances beginning at ordinal position 1. In embodiments that do not store the null value in the enum lookup array, the system may store user-defined enum instances beginning at ordinal position 0. Omitting the null value from the enum lookup array—even if the null value is a possible value of the enum type—reduces the array's memory footprint. Moreover, because null is a system constant, an array lookup is not required to return null.

In an embodiment, the system repeats the operations of FIG. 6 for multiple enum types. For example, the system may repeat the operations of FIG. 6 for multiple enum constructors called during class initialization. Once class initialization is complete, the system has a set of enum lookup arrays that represent the possible values of enums that support compact enum references. The system may maintain a table or other data structure that maps enum types to their respective enum lookup arrays.

### 4.2. Generating a Compact Enum Reference

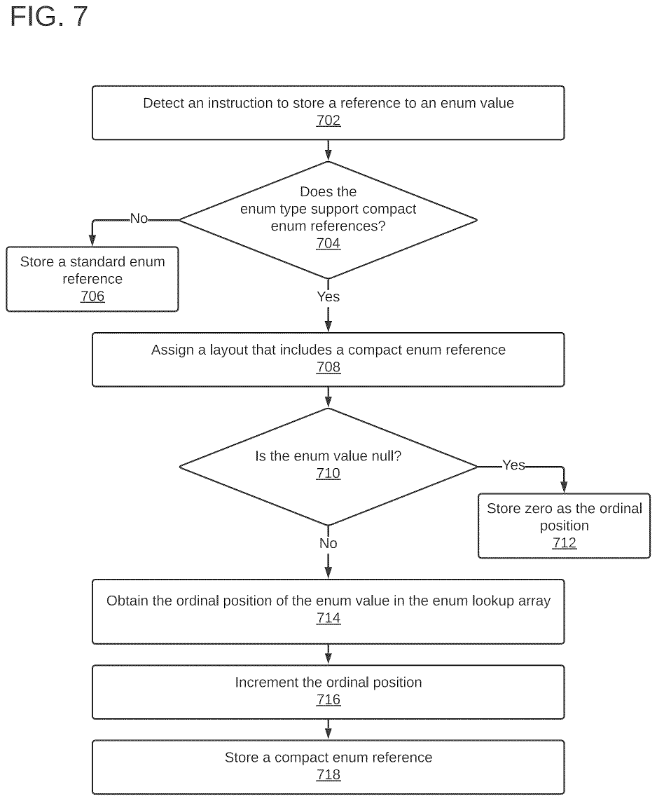

FIG. 7 shows a flowchart of operations for generating a compact enum reference in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, a system (e.g., system 500 of FIG. 5) detects an instruction to store a reference to an enum value of an enum type (Operation 702). For example, the system may detect an instruction to create an array of enum fields or load a class that includes an enum field. The system may detect the instruction during a loading phase, before executing the instruction.

Responsive to detecting the instruction to store the reference to the enum value of the enum type, the system determines if the enum type supports compact enum references (Operation 704). In an embodiment, an enum type supports compact enum references if the enum type corresponds to a simple enum. If the enum type does not support compact enum references, then the system stores a standard enum reference (Operation 706). The standard enum reference indicates the memory location of the corresponding enum instance itself.

If the enum type supports compact enum references, the system may assign to the array and/or class a field layout that includes a compact enum reference instead of a standard enum reference (Operation 708). A field layout indicates the sizes, types, and memory offsets of an object's fields in memory. Because compact enum references are smaller than standard enum references, a field layout that uses a compact enum reference consumes less memory than a field layout that uses a standard enum reference.

In an embodiment, the system determines if the enum value is null (Operation 710). If the enum value is null, the system may store 0 as the compact enum reference (Operation 712). Alternatively, another placeholder value may be used to indicate a null value. If the enum value is not null (e.g., it is a user-defined value), the system obtains the ordinal position of the enum value in the enum lookup array (Operation 714). In an embodiment, the ordinal position of the enum value corresponds to its position in the enum type declaration. For example, in an enum having the values {HEART, SPADE, DIAMOND, CLUB} , “HEART” has an ordinal position of 0, “SPADE” has an ordinal position of 1, “DIAMOND” has an ordinal position of 2, and “CLUB” has an ordinal position of 3. These ordinal positions may match the ordinal positions of the corresponding enum instances in the enum lookup array.

As noted above, one or more embodiments store 0 as the compact enum reference for the null value. However, if the null value is not stored in the enum lookup array, then the ordinal position of the first enum value is also 0. In such cases, one or more embodiments increment the ordinal positions of non-null values (Operation 716). In the example above, incrementing the ordinal position of “HEART” would yield an ordinal position of 1 instead of 0. Incrementing the ordinal position helps the system distinguish between a compact enum reference to the null value and a compact enum reference to the first user-defined enum value.

In an embodiment, the system stores a compact enum reference (Operation 718). Specifically, the system may store the ordinal position (incremented if applicable) as the compact enum reference. As discussed below, knowing the ordinal position allows the system to retrieve the enum value from the enum lookup array for a particular enum type. 4.3. Resolving an Enum Field Using a Compact Enum Reference

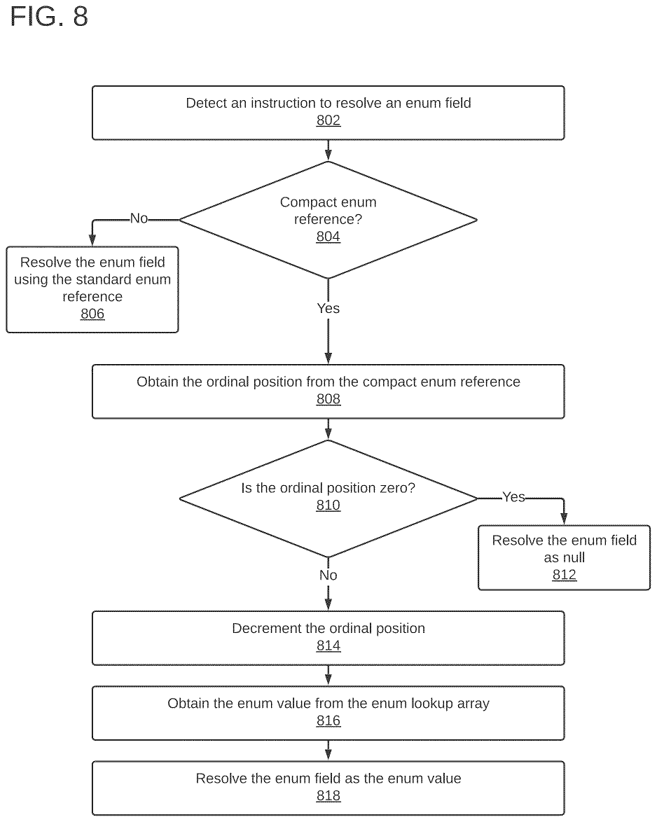

FIG. 8 shows a flowchart of operations for resolving an enum field using a compact enum reference in accordance with one or more embodiments. One or more operations illustrated in FIG. 8 may be modified, rearranged, or omitted. Accordingly, the particular sequence of operations illustrated in FIG. 8 should not be construed as limiting the scope of one or more embodiments.

In an embodiment, a system (e.g., system 500 of FIG. 5) detects an instruction to resolve an enum field (Operation 802). For example, the system may detect an instruction to operate on the value of an enum field, which requires knowing the enum value assigned to that field. How to resolve an enum field depends on the kind of enum reference used. Accordingly, the system determines if the enum reference is a compact enum reference (Operation 804). To determine if an enum reference is a compact enum reference, the system may determine if the enum type is marked as optimizable (e.g., as described with respect to Operation 608 of FIG. 6). Alternatively, the system may inspect the value and/or layout of the enum reference to determine if it is a compact enum reference.

If the enum reference is not a compact enum reference, then it is a standard enum reference. In this case, the system resolves the enum field using the standard enum reference (Operation 806). Specifically, the system uses the memory location indicated in the standard enum reference to retrieve the enum value from the enum instance stored at that location.

If the enum reference is a compact enum reference, then the system obtains the ordinal position from the compact enum reference (Operation 808). In an embodiment, the value of the enum reference itself is the ordinal position. For example, an ordinal position of 0 may be stored as 00000000, an ordinal position of 1 may be stored as 00000001, an ordinal position of 2 may be stored as 00000010, etc.

As discussed above, one or more embodiments store an ordinal position of 0 for the null value. The system determines if the ordinal position obtained from the compact enum reference is 0 (Operation 810). If the ordinal position is 0, then the system resolves the enum field as null (Operation 812). Thus, one or more embodiments allow for resolving an enum field as null without needing to perform a lookup in the enum lookup array.

As noted above, one or more embodiments store user-defined enum values in the enum lookup array beginning at the ordinal position of 0. Alternatively, as discussed herein, one or more embodiments store the null value at the ordinal position of 0 and user-defined enum values beginning at the ordinal position of 1. In embodiments where user-defined enum values begin at the ordinal position of 0, to avoid confusion with the null value, the ordinal position stored in the compact enum reference has been incremented. In such cases, when resolving an enum field, the system decrements the ordinal position obtained from the compact enum reference (Operation 814). In the example above, “HEARTS” is stored at ordinal position 0 in the enum lookup array, but the compact enum reference stores an ordinal position of 1. Decrementing the ordinal position gives the correct ordinal position of 0.

In an embodiment, the system obtains the enum value from the enum lookup array (Operation 816). Specifically, the system uses the ordinal position (decremented if applicable) as an index into the enum lookup array. The enum instance at that position in the enum lookup array stores the corresponding enum value. The system resolves the enum field as the enum value from the enum lookup array (Operation 818).

### 4.4. Additional Supports for Compact Enum References

### 4.4.1. Handling an Attempt to Add an Enum Value to an Enum Type After Class Initialization

As discussed above, one or more embodiments generate an enum lookup array during class initialization. Generally, a computer programmer declares the set of possible values of an enum type in source code. Thus, when the system generates the enum lookup array during class initialization, the array includes enum instances for all the possible values of the enum type. However, in some cases, a user may attempt to create a new enum value of an enum type after the class initialization phase. An enum reference to a new enum instance that stores the new enum value will be a standard enum reference. Because the memory allocated for a compact enum reference is not large enough to accommodate a standard enum reference, attempting to store a standard enum reference where the field layout calls for a compact enum reference may cause errors and/or system instability. Only part of the standard enum reference will fit in the designated memory, resulting in the system being unable to retrieve the new enum value from memory. Moreover, if part of the standard enum reference overwrites an adjacent field, data corruption may occur.

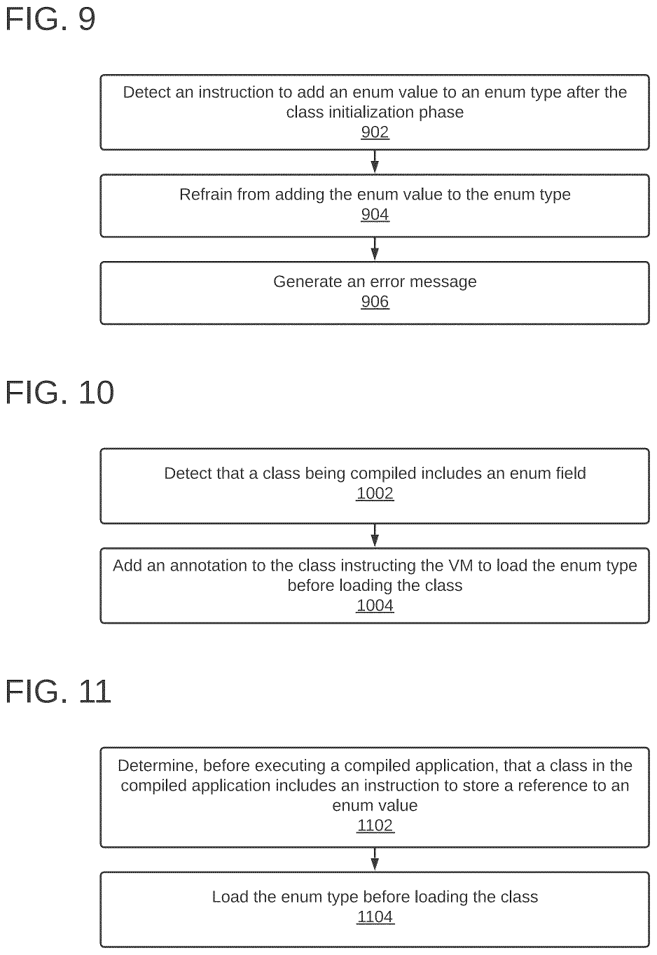

FIG. 9 shows a flowchart of operations for handling an attempt to add an enum value to an enum type after class initialization, in accordance with one or more embodiments. One or more operations illustrated in FIG. 9 may be modified, rearranged, or omitted. Accordingly, the particular sequence of operations illustrated in FIG. 9 should not be construed as limiting the scope of one or more embodiments.

In an embodiment, a system (e.g., system 500 of FIG. 5) detects an instruction to add an enum value to an enum type after the class initialization phase (Operation 902). For example, the system may detect a call to a constructor for an enum class after a corresponding enum lookup array has already been generated. Responsive to detecting the instruction, the system refrains from adding the enum value to the enum type (Operation 904). Refraining from adding the enum value to the enum type helps prevent the kinds of errors described above. In addition, the system may generate an error message (Operation 906). In Java environments, the system may throw an exception that includes the error message. Additionally or alternatively, the system may output the error message to a command line, present the error message in a graphical user interface, and/or log the error message to a log file.

### 4.4.2. Enforcing a Load Order That Supports Compact Enum References

One or more embodiments cannot always guarantee that an enum type has been loaded before encountering an instruction to use the enum type. Some VMs can load class files in any order and therefore may load a class file that uses an enum type before the enum type has been loaded. In such cases, the system has not yet had a chance to determine if the enum type supports compact enum references. In such cases, even if the enum type could have been optimized using techniques described herein, the VM will default to using standard enum references. The following discussion provides two possible approaches (Option A and Option B) to enforcing a load order that supports compact enum references.

### 4.4.2.1. Option A

FIG. 10 shows a flowchart of operations for enforcing a load order that supports compact enum references in accordance with one or more embodiments. One or more operations illustrated in FIG. 10 may be modified, rearranged, or omitted. Accordingly, the particular sequence of operations illustrated in FIG. 10 should not be construed as limiting the scope of one or more embodiments.

In an embodiment, a system (e.g., system 500 of FIG. 5) detects that a class being compiled includes an enum field (Operation 1002). Specifically, a compiler (e.g., the JavaC compiler) may detect the enum field at compile time. Responsive to detecting that the class being compiled includes the enum field, the compiler may annotate the class file with an annotation that instructs the VM to load the enum type before loading the class file (Operation 1004). The compiler may annotate all uses of enum types or may analyze the code and annotate only classes that include enum fields of enum types that support compact enum references. Upon encountering the annotation, the VM loads the enum type before loading the class file, ensuring that the enum type is marked at optimizable and that the enum lookup array has been generated in time to be used by the compiled class.

### 4.4.2.2. Option B

FIG. 11 shows another flowchart of operations for enforcing a load order that supports compact enum types in accordance with one or more embodiments. One or more operations illustrated in FIG. 11 may be modified, rearranged, or omitted. Accordingly, the particular sequence of operations illustrated in FIG. 10 should not be construed as limiting the scope of one or more embodiments.

In an embodiment, a system (e.g., system 500 of FIG. 5) determines, before executing a compiled application, that a class in the compiled application includes an instruction to store a reference to an enum value (Operation 1102). Responsive to this determination, the system loads the enum type before loading the class (Operation 1104). This approach is similar to Option B but operates on the compiled application and therefore does not require changes to the compiler. If the VM is configured to perform these operations, any otherwise suitable compiler can be used while still transparently supporting compact enum references.

### 5. Example of Compact Enum References

A detailed example is described below for purposes of clarity. Components and/or operations described below should be understood as one specific example that may not be applicable to certain embodiments. Accordingly, components and/or operations described below should not be construed as limiting the scope of any of the claims.

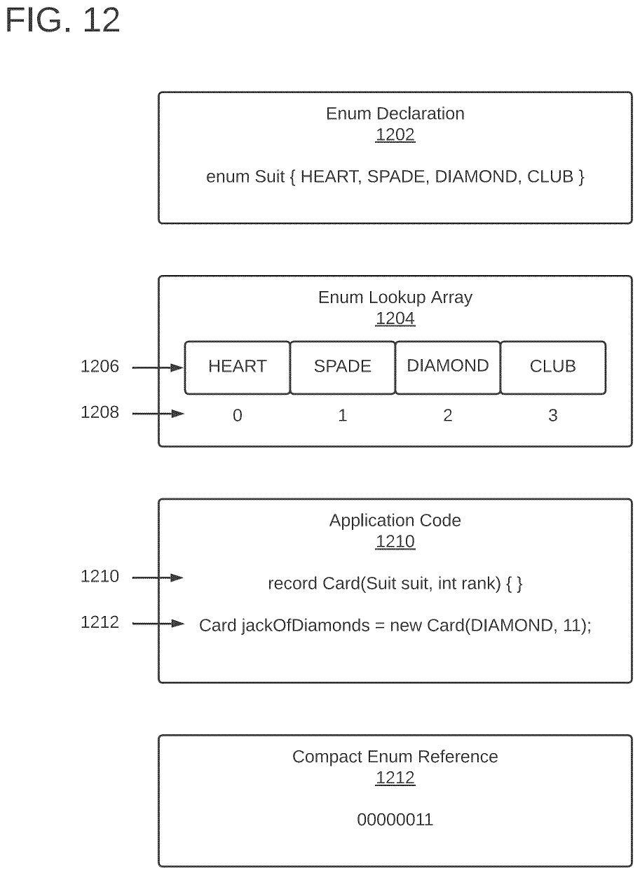

FIG. 12 shows a block diagram that illustrates an example of compact enum references in accordance with one or more embodiments. In this example, an online poker platform models a deck of cards with each suit represented as an enum and each rank represented as an integer. Some online poker platforms can have 200,000 or more players online at peak times. Assuming (unrealistically) that each player only plays one game at a time and each deck has 52 cards, that means an online poker platform could be tracking as many as 200,000/2×52=5,200,000 cards at a time.

Using standard enum references for the suit values of all 5.2 million cards would require 4 to 8 bytes per reference, a total of 41.6 megabytes. Meanwhile, using compact enum references would require no more than one byte per reference, a total of 5.2 megabytes. Thus, in this example, using compact enum references reduces the cards'memory footprint by 36.4 megabytes or 87.5%. If a bitmap were used and the null value were not stored in the enum lookup array, the compact enum references would require no more than 2 bits per card, a total of 1.3 megabytes. This approach reduces the cards'memory footprint by 40.3 megabytes or 96.9%.

In this example, an enum declaration 1202 declares an enum called “Suit” with the values HEART, SPADE, DIAMOND, and CLUB. When the VM loads the Suit enum, it marks the enum as optimizable and generates an enum lookup array 1204. In the enum lookup array 1204, enum instances 1206 store the possible values of the Suit enum at corresponding ordinal positions 1208 in the enum lookup array 1204.

Application code 1210 includes a declaration 1210 of a Card record that includes a suit and a rank. The suit is of the Suit enum type, and the rank is an int. When the system loads the Card type, it notices that the Suit enum is marked as optimizable and generates a field layout for the Card type that includes a compact enum reference for the suit field.

Application code 1210 further includes a declaration 1212 of a field (“jackOfDiamonds”) of the Card type with a suit of DIAMONDS and a rank of 11. The ordinal position of DIAMONDS in the enum lookup array is 2. Therefore, incrementing the ordinal position yields an ordinal position of 3, which the system stores in a compact enum reference 1212 as a single byte (00000011). To resolve the jackOfDiamonds field, the system decrements the ordinal position from the compact enum reference 1212 to obtain the ordinal position of 2. The system performs a lookup in the enum lookup array 1204 to obtain the value stored at the ordinal position of 2, i.e., DIAMONDS.

If a user were to attempt to add a fifth enum value (e.g., JOKER) to the Suit enum after class initialization, because a standard enum reference cannot fit into a field layout that is configured to use a compact enum reference, trying to store the standard enum reference into a Card field would cause an error.

### 6. Using Compact Enum References With Non-Nullable Fields

As discussed above, one or more embodiments include the null value as a possible value for all enum types. Additionally or alternatively, one or more embodiments may support non-nullable types, i.e., types that do not allow the null value. Without a null value, the ordinal position of 0 applies unambiguously to the first user-defined enum value. Therefore, in such instances, it is not necessary to increment the ordinal position when storing a compact enum reference or decrement the ordinal position when performing a lookup of the enum value in the enum lookup array.

### 7. Using Compact Enum References With Value Types

Some programming languages (e.g., some versions of Java) support value types. A value type is an immutable type that does not have an identity and does not support inheritance. Like a primitive, a value type is referenced by its value, not by an object reference. A value-based class is a wrapper class for a value type. A value-based class is final, includes only final fields, and can extend the Object class or a hierarchy of abstract classes that do not declare instance fields. A value-based class does not declare an accessible constructor; instead, a value-based class can be instantiated through a factory method. In general, because value-based classes do not have a reference-based identity, they use less memory than standard object classes. The Java Virtual Machine (JVM) can reuse an existing instance of a value-based class or create a new one as needed. Because value-based classes do not require synchronization, they tend to improve performance in multi-threaded applications in comparison to types that do require synchronization. In general, because of their limited functionality, value-based classes occupy less memory than standard object classes. One or more embodiments use compact enum reference with value types (e.g., by generating an array of value type instances and using the instances'respective ordinal positions as references instead of standard object references), adding to the memory-sparing benefits of value types.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

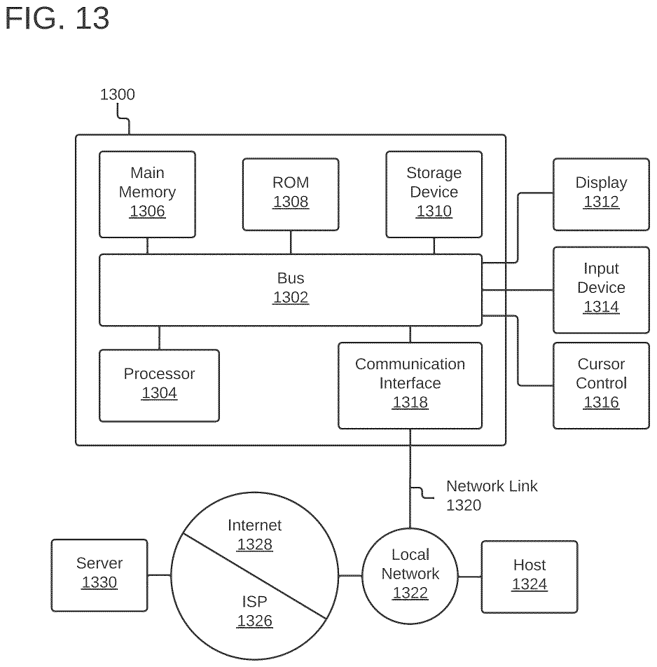

For example, FIG. 13 is a block diagram that illustrates a computer system 1300 upon which an embodiment of the invention may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1310. Volatile media includes dynamic memory, such as main memory 1306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
detecting, by a virtual machine (VM), an instruction to store a first reference to a first enum value of a first enum type;
responsive to encountering the instruction to store the first reference to the first enum value:
determining, by the VM, a first ordinal position of the first enum value in an enum lookup array comprising a set of possible values of the first enum type;
storing, by the VM, the first ordinal position of the first enum value as the first reference to the first enum value of the first enum type;
wherein the method is performed by at least one device including a hardware processor.

2. The method of claim 1, wherein storing the first ordinal position of the first enum value as the first reference to the first enum value consumes no more than one byte of memory for the first reference.

3. The method of claim 1, further comprising:
incrementing the first ordinal position before storing the first ordinal position of the first enum value as the first reference to the first enum value.

4. The method of claim 1, further comprising:
determining, by the VM, that the first enum type supports compact enum references;
wherein storing the first ordinal position of the first enum value as the first reference is contingent on determining that the first enum type supports compact enum references.

5. The method of claim 1, wherein the instruction to store the first reference to the first enum value of the first enum type comprises an instruction to generate an array of values of the first enum type, the method further comprising:
assigning to the array of values of the first enum type, by the VM, a field layout comprising compact enum references instead of standard object references at respective positions in the array.

6. The method of claim 1, wherein the instruction to store the first reference to the first enum value of the first enum type comprises an instruction to load a class comprising a field declared as the first enum type, the method further comprising:
assigning to the class, by the VM, a field layout comprising a compact enum reference instead of a standard object reference for the field.

7. The method of claim 1, further comprising:
detecting, by the VM during a class initialization phase, an instruction to construct the first enum type;
responsive to detecting the instruction to construct the first enum type:
generating the enum lookup array;
storing in the enum lookup array, by the VM, a set of enum instances corresponding respectively to the set of possible values of the first enum type.

8. The method of claim 7, further comprising:
storing, by the VM, a null value at a zeroth ordinal position of the enum lookup array.

9. The method of claim 7, wherein the enum lookup array is one of a plurality of enum lookup arrays associated, respectively, with a plurality of enum types.

10. The method of claim 1, further comprising:
encountering, by the VM, an instruction to resolve an enum field associated with the first reference;
responsive to encountering the instruction to resolve the enum field:
obtaining, by the VM, the first ordinal position stored in the first reference;
obtaining, by the VM from the enum lookup array, the first enum value stored at the first ordinal position in the enum lookup array;
resolving, by the VM, the enum field as the first enum value.

11. The method of claim 10, further comprising:
decrementing, by the VM, the first ordinal position before obtaining the first enum value stored at the first ordinal position in the enum lookup array.

12. The method of claim 1, further comprising:
detecting, by the VM after a class initialization phase in which the JVM constructs the first enum type, an instruction to add a second enum value to the first enum type;
responsive to detecting the instruction to add the second enum value to the first enum type after the class initialization phase:
refraining, by the VM, from adding the second enum value to the first enum type;
generating, by the VM, an error indicating that the second enum value was not added to the first enum type.

13. The method of claim 1, further comprising:
detecting, by a compiler, that a class being compiled comprises a field declared as the first enum type;
responsive to detecting that the class being compiled comprises the field declared as the first enum type:
adding to the class, by the compiler, an annotation instructing the JVM to load the first enum type before loading the class.

14. The method of claim 1, further comprising:
determining, by the VM before executing a compiled application, that a class in the compiled application comprises the instruction to store the first reference to the first enum value of the first enum type;
responsive to determining that the class in the compiled application comprises the instruction to store the first reference to the first enum value of the first enum type:
loading, by the VM, the first enum type before loading the class.

15. The method of claim 1, wherein storing the first ordinal position of the first enum value as the first reference to the first enum value of the first enum type comprises storing the first ordinal position in a first subset of bits of a byte, the method further comprising:
storing, as a second reference to a second enum value, a second ordinal position of the second enum value in a second subset of bits of the byte.

16. The method of claim 15, wherein the first enum type has N possible non-null values and the first subset of bits comprises a minimum number of bits needed to represent N ordinal positions.

17. The method of claim 15, wherein the first enum type has N possible non-null values and the first subset of bits comprises a minimum number of bits needed to represent N+1 ordinal positions.

18. The method of claim 15, wherein the second enum value is of a second enum type that is different than the first enum type.

19. One or more non-transitory computer-readable media comprising instructions that, when executed by one or more hardware processors, cause performance of operations comprising:
detecting, by a virtual machine (VM), an instruction to store a first reference to a first enum value of a first enum type;
responsive to encountering the instruction to store the first reference to the first enum value:
determining, by the VM, a first ordinal position of the first enum value in an enum lookup array comprising a set of possible values of the first enum type;
storing, by the VM, the first ordinal position of the first enum value as the first reference to the first enum value of the first enum type.

20. A method comprising:
detecting, by a virtual machine (VM) during a class initialization phase, an instruction to construct an enum type;
responsive to detecting the instruction to construct the enum type:
generating an enum lookup array;
storing in the enum lookup array, by the VM, a set of enum instances corresponding respectively to a set of possible values of the enum type;
detecting, by the VM, an instruction to store a reference to an enum value of the first enum type;
responsive to encountering the instruction to store the reference to the enum value:
determining, by the VM, an ordinal position of the enum value in the enum lookup array;
incrementing, by the VM, the ordinal position before storing the ordinal position of the enum value as the reference to the enum value;
storing, by the VM, the ordinal position of the enum value as the reference to the enum value;
wherein storing the ordinal position of the enum value as the reference to the enum value consumes no more than one byte of memory for the reference;
encountering, by the VM, an instruction to resolve the reference;
responsive to encountering the instruction to resolve the reference:
obtaining, by the VM, the ordinal position stored in the reference;
decrementing, by the VM, the ordinal position before obtaining the enum value stored at the ordinal position in the enum lookup array;
obtaining, by the VM from the enum lookup array, the enum value stored at the ordinal position in the enum lookup array;
resolving, by the VM, the reference as the first enum value.
